(19) United States
(12) Patent Application Publication
(10) Pub. No.: US 2021/0056513 A1
(43) Pub. Date: Feb. 25, 2021

(54) TECHNIQUES FOR DETECTING WHEN INVITEES ARE PRESENT OR REMOTE

(71) Applicant: Lenovo (Singapore) Pte. Ltd., Singapore (SG)

(72) Inventors: Jonathan Co Lee, Cary, NC (US); Russell Speight VanBlon, Raleigh, NC (US)

(21) Appl. No.: 16/544,275

(22) Filed: Aug. 19, 2019

(51) Int. Cl. G06Q 10/10; G06N 5/04

(52) U.S. Cl. CPC G06Q 10/1095; G06N 5/04

(57) ABSTRACT

In one aspect, a device includes a processor programmed to infer, using past and future information from electronic calendars, whether invitees to a meeting will attend the meeting physically or remotely. An invitation may be generated automatically, a room may be selected automatically, and a remote call-in link may be generated automatically in response to the inferences.

### FIELD

The present application relates to technically inventive, non-routine solutions that are necessarily rooted in computer technology and that produce concrete technical improvements.

### BACKGROUND

When a person electronically schedules a meeting and invites attendees, he does not necessarily know how many attendees will be present or join remotely, which affects the room type or meeting environment. The meeting invitation can also be forwarded by invitees to other people, meaning that the inviting host loses control over the meeting space. For instance, an inviting host may invite only four people and schedule a small meeting accordingly, but the invitation may be forwarded to additional people.

Further, inviting hosts often must guess which invitees will attend in person based on their location and responses, and so must inquire of invitees as to whether they will be physically present or not, creating churn through emails and communications. Should the inviting host learn that the initial guess as to number of invitees attending remotely and in person changes, the planned meeting location may also require updating, again creating communication churn.

There are currently no adequate solutions to the foregoing computer-related, technological problem.

### SUMMARY

Accordingly, in one aspect a first device includes at least one processor and storage accessible to the processor. The storage includes instructions executable by the processor to receive input of meeting invitees. The instructions are executable to generate a list of invitees based on the input. Also, the instructions are executable to automatically access electronic calendar information of at least a first of the invitees and based at least in part on the calendar information, infer whether the first invitee will attend the meeting in person or remotely. The instructions are executable to, based at least in part on inferring whether the first invitee will attend the meeting in person or remotely, automatically generate a link to remotely access the meeting and/or select a room for the meeting and then transmit at least one message to at least one of the invitees indicating the room, the link, or both the room and the link.

In some embodiments the instructions may be executable to automatically add to an invite message to the meeting a query to the invitees asking whether an invitee plans to attend the meeting in person or remotely. In such embodiments, the instructions may be executable to, based on one or more of invitee responses to the query, automatically search available rooms and select a room based on a number of physical attendees of the meeting as inferred or confirmed by invitee responses.

In example implementations the instructions may be executable to infer that a second invitee will attend the meeting remotely responsive to an electronic calendar of the second invitee indicating that the second invitee will be out of town on a date of the meeting.

In some embodiments the instructions may be executable to infer that a second invitee will attend the meeting remotely responsive to an electronic calendar of the second invitee indicating that the second invitee has previously attended meetings remotely even when the previously attended meetings and the second invitee were in the same building.

In example implementations the instructions may be executable to infer whether a second invitee will attend the meeting physically based at least in part on an identification of the second invitee.

In some embodiments the instructions may be executable to infer whether a second invitee will attend the meeting physically based at least in part on a subject matter of the meeting.

In example implementations the instructions may be executable to infer whether a second invitee will attend the meeting physically based at least in part on a date of the meeting.

In some embodiments the instructions may be executable to infer whether a second invitee will attend the meeting physically based at least in part on a time of the meeting.

If desired, the instructions may be executable to modify the room, the link, or both the room and the link based at least in part on geolocation of at least the first invitee.

In another aspect, a computer readable storage medium (CRSM) that is not a transitory signal includes instructions executable by at least one processor to detect when invitees will be present or remote to a meeting based on future or past calendar data and user verification and geographic tracking, and to generate an invitation to the meeting based at least in part on the detection step.

In another aspect, a method includes receiving input of meeting invitees, receiving input of meeting time and generating a list of invitees based on the inputs. The method also includes automatically accessing electronic calendar information of at least a first of the invitees. The method further includes, based at least in part on the calendar information, inferring whether the first invitee will attend the meeting in person or remotely, and based at least in part on inferring whether the first invitee will attend the meeting in person or remotely, automatically generating a link to remotely access the meeting and/or selecting a room for the meeting. A message is transmitted to the invitees indicating the room, the link, or both the room and the link.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of an example system of inviter (host) and invitee devices;

FIG. 4 schematically illustrates a software plugin to a calendaring system including a database consistent with preset principles;

FIG. 5 is a flow chart of example logic consistent with present principles;

FIGS. 6 and 7 are screen shots of example user interfaces (UI) that may be presented on the device of an invitee consistent with present principles;

FIGS. 8 and 9 are screen shots of example user interfaces (UI) that may be presented on the device of an inviting host consistent with present principles; and

FIG. 10 shows an example settings user interface (UI) consistent with present principles.

### DETAILED DESCRIPTION

Techniques are described to detect when invitees will be present or remote to a meeting based on future or past calendar data and user verification and geographic tracking. These techniques may include use of a software plugin to an existing calendaring service asking invitees if they are attending physically or virtually. Modifications to calendar events may be made after an invitee has already accepted a meeting.

Calendaring data may be implemented by software that tracks the personal electronic calendars of invitees to make inferences regarding whether the invitees are likely to attend a meeting physically or virtually. For example, if an invitee has multiple meetings on the day during which a particular invited meeting is scheduled and in the same general location as the invited meeting is scheduled to occur, and the invitee's calendar indicates that the invitee attended the other meetings in person (physical attendance) versus remotely (virtual attendance), it may be inferred that the invitee will physically attend the invited meeting.

Additionally, geo-location or user tracking may be used to infer whether and when invitees will join an invited meeting in person. For example, a companion application (“app”) may connect to meeting room hubs that detect who is physically in the meeting rooms and thereby infer, based on proximity of the meeting rooms to the location of the invited meeting, whether the invitee will physically or remotely join the invited meeting. Chip-based badging systems may provide such information as well as other technologies such as voice recognition and machine vision. The calendaring service using geo-location can update the invitation to indicate whether an invitee is or is not in the building in which the invited meeting is to occur.

A software plugin may be added to, e.g., each invitee's calendaring service allowing invitees to respond how they are attending the meeting (physically or virtually). A drop down menu or prompt or other user interface may be provided that indicates whether the invitee is attending in person or virtually”, and this information is sent to the meeting host's device.

Based on both inference from the electronic calendars and responses to the invitation, the device of the inviting host can system may access a database of rooms that correlates rooms with both availability by time and capacity, and select a room that is both available at the invited time and that has capacity for the number of invitees inferred or confirmed to be physically present. The device of the inviting host may also prompt or alert the meeting host if the number of people attending in person exceeds the capacity of the selected room.

Thus, when sending out an invite, the system determines whether an invitee is expected to attend in person or remotely and includes an online meeting link in the invite. In specific examples, active directory (AD) functionality may be leveraged. In AD, there is a location associated with each user. When users are added to a meeting with a different AD location at the time of the calendar event, an online meeting link may be generated automatically or the host may be prompted to provide one.

The host may be notified of an invitee likely to be remote. The host may be prompted to include an online meeting link before the invite is sent, or the system may automatically add the link for the host as the invite goes out. A meeting link may always be automatically generated by the system, which can notify the host at the time of the meeting if someone is likely (or confirmed) to be remote. If all invitees are in physical attendance, a hub-like device or other device may notify the host that no call-in meeting link is necessary.

When the meeting invitation is transmitted, a plugin or other software in the calendaring system of each invitee may prompt the invitee to respond to the meeting to tell the organizer if they are joining in person or remotely. If responses come back to the organizer that attendees are attending remotely, an online meeting link may be automatically created and the meeting is updated or prompts the organizer to make the change manually.

Prior to delving into the details of the instant techniques, with respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

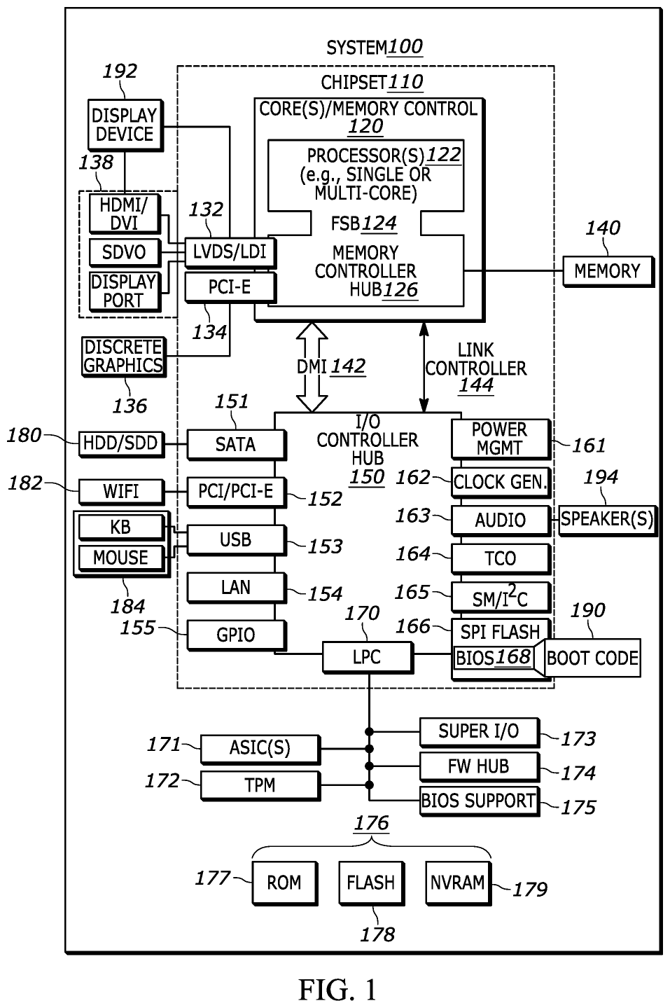

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

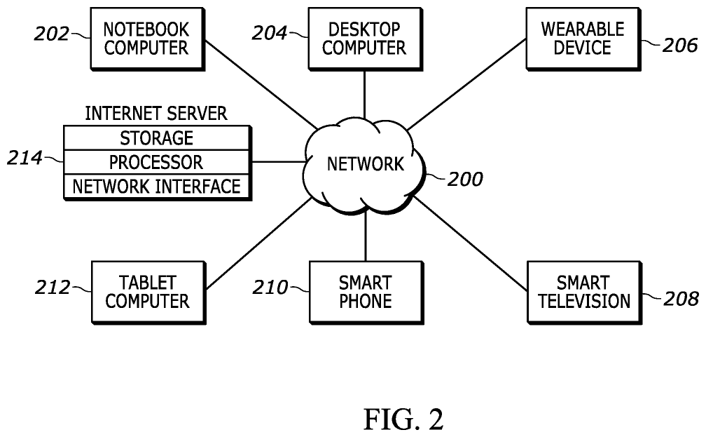

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

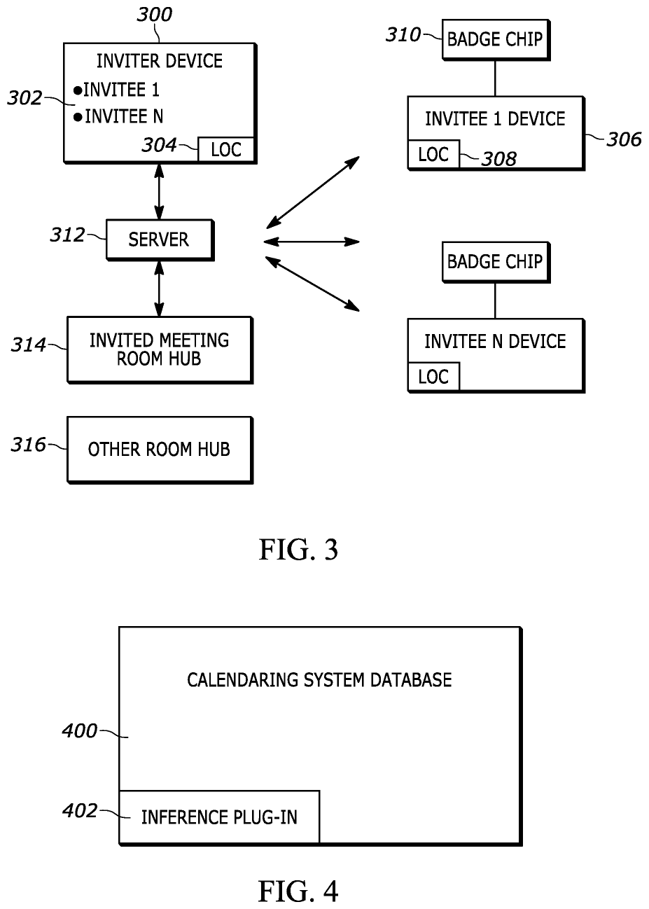

FIG. 3 illustrates a system in which a device 300 of an inviter (also referred to herein as “host” or “inviting host”) to a meeting. Any of the devices discussed herein may be used to implement any of the devices in FIG. 3. The device 300 may include (and may present as shown) a list 302 of invitees, typically input by the host. The device 300 may include a geolocation device 304 such as, for example, a global positioning satellite (GPS) receiver.

Typically, each invitee in the list 302 is associated with a respective invitee device 306 with geolocation device 308. Each invitee also may be associated with a badge chip 310 that identifies the invitee, typically to an enterprise of which the invitee is a member. A badge chip 310 may wireless communicate using near field communication (NFC) with other computerized devices.

One or more servers 312 may communicate with the devices of the system. A computerized hub 314 in the meeting room, selected as described further below in response to the invitation generated by the host, may be located in the selected meeting room and may communicate via NFC with badge chips 310. Other hubs 316 in other rooms in the same or different building as the meeting room may likewise communicate with bade chips.

Techniques described herein may be implemented in software executed by respective processors in respective devices, including processors of the host device 300 and the invitee devices 306. As shown in FIG. 4, the software may be added to a calendaring system 400 (which may include a database) of a device in the form of a plug-in 402 to, among other things, infer whether an invitee will attend an invited meeting in person or remotely.

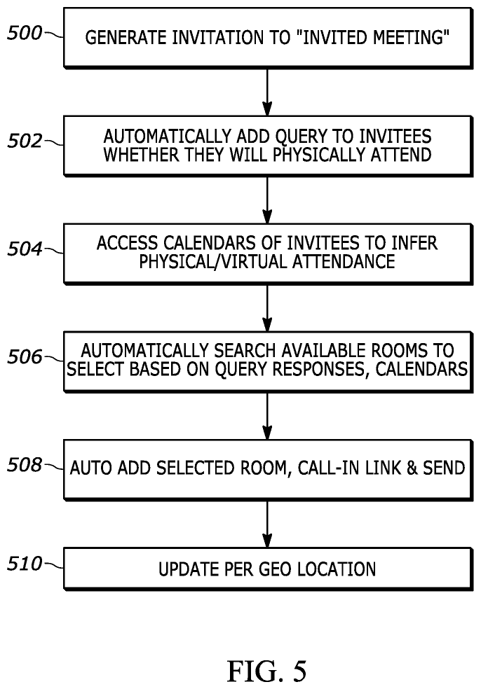

FIG. 5 shows example logic that may be executed by a device such as the system 100 in accordance with present principles. Note that while FIG. 5 illustrates the logic in flow chart format, state logic or other equivalent logic may be used.

Commencing at block 500, a host may use the host device 300 in FIG. 3 to generate an invitation to an invited meeting. This may entail inputting the names (or other identification indicia) of desired attendees as the list 302 of invitees. It may also entail inputting a meeting data and time, and if desired a meeting location. The meeting location that is input may be a specific room in a specific building, although as described below a room may be automatically selected for the host, in which case the input of location may be general and may allow for the selection from among multiple candidate rooms, e.g., “on campus”.

Moving to block 502, in some implementations the host device 300, server 312, or other system device may automatically add to the invitation a query to the invitees asking each invitee whether he or she plans to attend the meeting in person (physical attendance) or remotely (virtual attendance). Also, the logic may move to block 504 to access, via the invitee devices 306, server 312, and/or other devices in the system electronic calendars of the invitees to infer whether each invitee will attend the meeting physically or virtually. In addition to the inference examples given above, it may be inferred that an invitee will attend remotely if the electronic calendar of the invitee indicates that the invitee will be out of town on the date of the meeting. It may also be inferred that an invitee will attend remotely if the electronic calendar of the invitee indicates that the invitee has previously attended meetings remotely even when the meetings and the invitee are in the same building.

Other inference heuristics are contemplated herein. For example, it may be inferred that certain employees and/or classes of employees are likely to physically attend a meeting while other employees or classes are likely to remotely attend. It may be inferred that a certain subject matter of a meeting will induce all invitees to physically attend and that other subject matter will induce most or all invitees to remotely attend. It may be inferred based on a date of the meeting that most or all invitees will remotely attend, e.g., a meeting date in January may produce an inference that invitees will remotely attend whereas a meeting date in April may produce an inference that invitees will physically attend. It may be inferred based on a time of the meeting that most or all invitees will remotely attend, e.g., a meeting time at 7 AM may produce an inference that invitees will remotely attend whereas a meeting time at LOAM may produce an inference that invitees will physically attend.

Proceeding to block 506, based on one or more of invitee responses to the attendance query at block 502 and the attendance inferences from block 504, the logic may automatically search available rooms in the location designated by the host and select a room based on the number of physical attendees as inferred or confirmed by invitee responses. A database of rooms may be accessed which correlates rooms to vacancy times (availability) and capacity, and the smallest available room with sufficient capacity to seat all invitees confirmed or inferred to be in physical attendees may be selected.

Block 508 indicates that within the process of FIG. 5, the selected room from block 508 and an automatically generated or host-generated call-in link to the meeting (such as a phone number or website) may be sent to all invitees. Either a second massage may be sent after the query at block 502 or the message at block 508 may be generated based on inference only from block 504 and sent as an initial message that contains the attendance query, with responses to the attendance query then precipitating a different room selection if the number of confirmed physical attendees differs from the number of initially inferred physical attendees. Thus, the order of blocks in FIG. 5 may be implemented differently than shown.

Block 510 indicates that geolocation of invitees according to, for example, any of the methods shown and discussed herein may be received by, for instance, the host device 300, with the meeting particulars updated accordingly. For instance, even if an invitee has confirmed physical attendance in response to the query at block 502, if geolocation information associated with the invitee indicates that the invitee is out of town the day of the meeting, the status of the invitee may be changed from “physical attendee” to “remote attendee” and if desired a new meeting room selected to account for the decreased number of physical attendees. A new message in such a case may be automatically generated and sent to the invitees indicating the new room and, if not already provided (because no invitee previously was indicated as being a remote attendee), a call-in link. Or, if an invitee has confirmed remote attendance in response to the query at block 502, if geolocation information associated with the invitee indicates that the invitee is in the room just prior to the invited meeting, the status of the invitee may be changed from “remote attendee” to “physical attendee” and if desired a new meeting room selected to account for the increased number of physical attendees. A new message in such a case may be automatically generated and sent to the invitees indicating the new room.

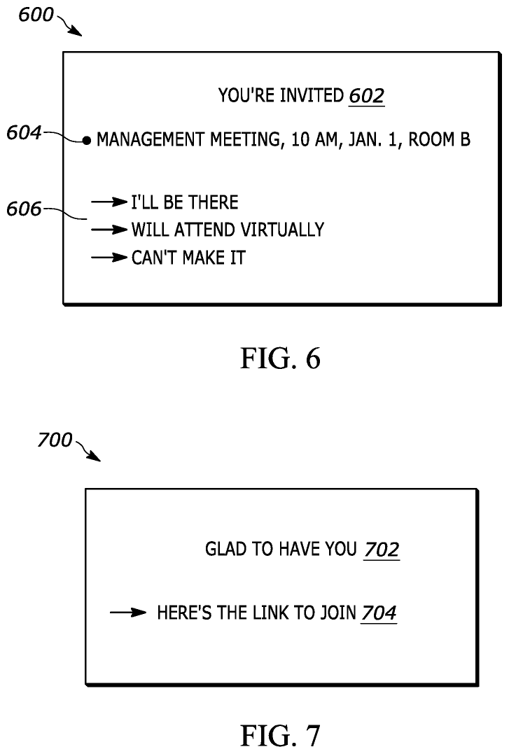

FIG. 6 illustrates a screen shot of a user interface (UI) 600 that may be presented on an invitee device 306 pursuant to FIG. 5. The UI 600 includes a meeting invitation 602 along with particulars 604 of the meeting, including, if desired, meeting name, time, date, and room. Selectors 606 may be provided to enable the invitee to indicate whether the invitee will attend physically or remotely (or not at all).

FIG. 7 illustrates a screen shot of a UI 700 that may be presented on an invitee device 306 pursuant to FIG. 5, either as part of the UI 600 in FIG. 6 or separately therefrom. As shown, the UI 700 can include a welcome message 702 and a link 704 to join the meeting remotely, for instance by telephone, web link, or both.

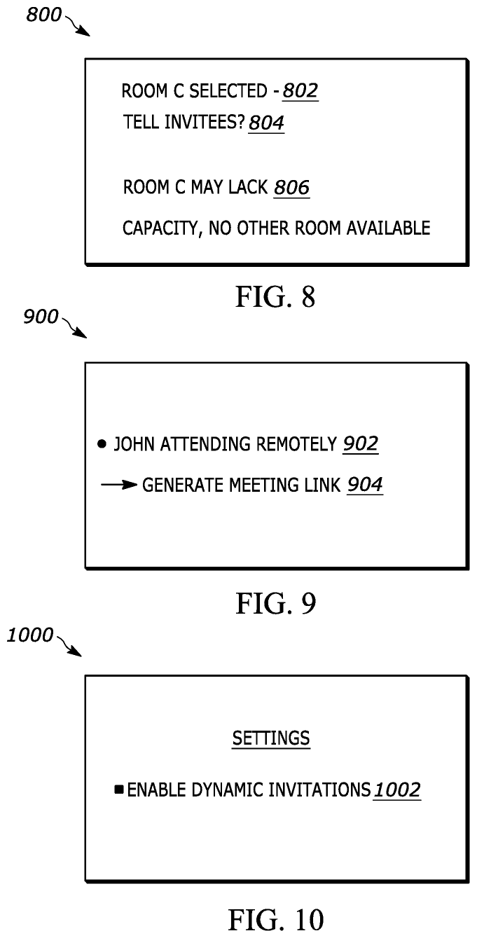

FIG. 8 illustrates a screen shot of a UI 800 that may be presented on a host device 300. The UI 800 may include an indication 802 of an automatically selected room consistent with principles above. It may also include a selector 804 to transmit a message to the invitees regarding the room number. The UI 800 may further include a warning or prompt 806 advising that the capacity of the selected room may be inadequate and also advising as to the availability of other nearby meeting rooms.

FIG. 9 illustrates a screen shot of a UI 900 that may be presented on a host device 300. The UI 900 may include an indication 902 that a particular invitee has been inferred to be a remote attendee or has confirmed he will be a remote attendee consistent with FIG. 5. The UI 900 may also include a selector 904 operable to cause the automatic generation of a meeting link (phone number, web link, etc.) that, upon selection of the selector 904, is automatically transmitted to the remote invitee. Alternatively the host may manually input a meeting link.

Additionally, in some embodiments one or more of the devices described herein may present a settings user interface 1000 on a display, as shown in FIG. 10. For instance, the UI 1000 may be presented on the display of the host device 300. The UI 1000 may indicate one or more settings to configure in accordance with present principles. For instance, the UI 1000 may include a selector 1002 selectable by directing touch or cursor input to the adjacent check box to enable the host device 300 (or another device) to undertake the functions described herein. For instance, the selector 1002 may be selected to set, enable, or configure the device to undertake the logic of FIG. 5.

It may now be appreciated that present principles provide for an improved computer-based user interface that improves the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
receive input of meeting invitees;
generate a list of invitees based on the input;
automatically access electronic calendar information of at least a first of the invitees;
based at least in part on the calendar information, infer whether the first invitee will attend the meeting in person or remotely;
based at least in part on inferring whether the first invitee will attend the meeting in person or remotely, automatically execute at least one of: generate a link to remotely access the meeting, select a room for the meeting; and
transmit at least one message to at least one of the invitees indicating the room, the link, or both the room and the link.

2. The device of claim 1, wherein the instructions are executable to:
automatically add to an invite message to the meeting a query to the invitees asking whether an invitee plans to attend the meeting in person or remotely.

3. The device of claim 1, wherein the instructions are executable to:
infer that a second invitee will attend the meeting remotely responsive to an electronic calendar of the second invitee indicating that the second invitee will be out of town on a date of the meeting.

4. The device of claim 1, wherein the instructions are executable to:
infer that a second invitee will attend the meeting remotely responsive to an electronic calendar of the second invitee indicating that the second invitee has previously attended meetings remotely even when the previously attended meetings and the second invitee were in the same building.

5. The device of claim 1, wherein the instructions are executable to:
infer whether a second invitee will attend the meeting physically based at least in part on an identification of the second invitee.

6. The device of claim 1, wherein the instructions are executable to:
infer whether a second invitee will attend the meeting physically based at least in part on a subject matter of the meeting.

7. The device of claim 1, wherein the instructions are executable to:
infer whether a second invitee will attend the meeting physically based at least in part on a date of the meeting.

8. The device of claim 1, wherein the instructions are executable to:
infer whether a second invitee will attend the meeting physically based at least in part on a time of the meeting.

9. The device of claim 2, wherein the instructions are executable to:
based on one or more of invitee responses to the query, automatically search available rooms and select a room based on a number of physical attendees of the meeting as inferred and/or confirmed by invitee responses.

10. The device of claim 1, wherein the instructions are executable to:
modify the room, the link, or both the room and the link based at least in part on geolocation of at least the first invitee.

11. A computer readable storage medium (CRSM) that is not a transitory signal, the computer readable storage medium comprising instructions executable by at least one processor to:
detect when invitees will be present or remote to a meeting based on future or past calendar data and user verification and geographic tracking; and
generate an invitation to the meeting based at least in part on the detection.

12. The CRSM of claim 11, wherein the instructions are executable to:
access calendaring data implemented by software and associated with the invitees to make inferences regarding whether the invitees are likely to attend a meeting physically or virtually.

13. The CRSM of claim 11, wherein the instructions are executable to:
access geolocation of invitees to infer whether and when invitees will join an invited meeting in person.

14. The CRSM of claim 13, wherein geolocation is determined using meeting room hubs.

15. The CRSM of claim 13, wherein geolocation is determined using a chip-based badging system.

16. The CRSM of claim 13, wherein geolocation is determined using voice and/or face recognition.

17. The CRSM of claim 11, wherein the instructions are executable to:
automatically insert into the invitation a phone or network link to the meeting based at least in part on the detection.

18. The CRSM of claim 11, wherein the instructions are executable to:
automatically insert into the invitation a room identification for the meeting based at least in part on the detection.

19. A method, comprising:
receiving input of meeting invitees;
receiving input of meeting time;
generating a list of invitees based on the inputs;
automatically accessing electronic calendar information of at least a first of the invitees;
based at least in part on the calendar information, inferring whether the first invitee will attend the meeting in person or remotely;
based at least in part on inferring whether the first invitee will attend the meeting in person or remotely, automatically executing at least one of: generating a link to remotely access the meeting, selecting a room for the meeting; and
transmitting at least one message to at least one of the invitees indicating the room, the link, or both the room and the link.

20. The method of claim 19, comprising:
automatically adding to an invite message to the meeting a query to the invitees asking whether an invitee plans to attend the meeting in person or remotely.
